(19) United States
(12) Patent Application Publication
(10) Pub. No.: US 2010/0287117 A1
(43) Pub. Date: Nov. 11, 2010

(54) FINANCIAL ASSET MANAGEMENT SYSTEM

(76) Inventor: Gye-young Lee, Seoul (KR)

Correspondence Address: Haesung Kwon, 6467 Devonshire Dr., San Jose, CA, 95129, US

(21) Appl. No.: 12/647,494

(22) Filed: Dec. 27, 2009

(30) Foreign Application Priority Data
May 10, 2009 (KR) 10-2009-0042037

(51) Int. Cl. G06Q 40/00

(52) U.S. Cl. 705/36 R

(57) ABSTRACT

A financial asset/stock investment system and a method for performing necessary and optimal transactions periodically in response to fluctuating stock market. The system includes a data set of investment terms for clients, a stock analysis logic for calculating the stock investment amount and determining the stock investment ratio defined as the ratio of amount of stock to be held and transacted buying and/or selling stocks, and a stock optimal transaction logic for automatic buying and/or selling stocks recommended from investment terms, stock index, stock investment amount and transaction-buying and/or selling amount. The recommendation from the system is made to profit from stock trading based on the stock investment ratio.

### CROSS-REFERENCE TO RELATED APPLICATIONS

This application claims the benefit of the filing date of Korean Patent Application Ser. No. 10-2009-0042037, filed on May 10, 2009, entitled “Financial Asset Investment Management System and that Method,” which is hereby incorporated by reference by its entirety.

### TECHNICAL FIELD

The present invention relates to a system and method for managing financial asset investment; more particularly, a system and method for differentially applying the optimum ratio of investment for a stock in response to the change in the stock price.

### BACKGROUND OF THE INVENTION

In recent years, advancement of information and communication technologies, as well as the globalization of borderless capital markets, has lead to quite a few financial asset investment management systems proposed through on-line automation. In general financial asset investment management systems, there are two steps involved in the decision making process. The first step is for investors to find the desired price and volume of a specific investment stock, and the second step is to perform a transaction according to transaction terms. The (stock) investor, using his computer system connected to a stock transaction system, confirms the balance of account, stock volume, current price of the stock and closing price of the stock. Therefore, the investor confirms his account and the current price of the stock, places a buy/sell order of shares of the stock, and the entire order is conveyed to the stock transaction system.

The computer system of the stock exchange system receives the orders from stock brokerage firms and performs transactions at a specific price of the stock by comparison of the investor's selling price and volume or equivalently shares with buying price and volume of the stock.

However, the investor needs to analyze market trends before he decides on transaction terms and must reflect the analyzed results on the transaction terms. Typically a high degree of professional knowledge is required to perform an optimum market analysis and to prepare associated transaction terms. Therefore, it can be a daunting job for the general public to decide transaction terms under market conditions. Finding optimal time for a transaction in the ever-changing market is also a challenging task to the individual stock investor as well as institutional stock investors.

To overcome the difficulties in managing stock transactions, financial asset investment management systems were proposed to make repetitive transactions under preset conditions and trends on behalf of the individual stock investor and institutional stock investors.

Existing financial asset investment management systems include multiple stages to complete the transactions through data communication networks. The first stage collects desired buy/sell terms; the second stage places an order to buy or sell under the buy/sell terms; the third stage confirms the transaction; and the fourth stage places a new order to buy or sell according to the predetermined transaction terms when the order to buy or sell is completed.

When an order to buy or sell is placed, existing financial asset investment management systems execute an order to buy/sell under the predetermined transaction terms. Investors confirm the transaction of buy/sell order, and therefore are relieved from entering new buy/sell terms.

But the existing systems only work when the market is moving in a predictable fashion and under the corresponding transaction terms. Thus, there is a need for a system that can effectively cope with the ever changing stock market to maximize profit and minimize loss out of the stock transaction.

### SUMMARY OF THE INVENTION

The present invention provides a method of financial asset investment management and a system to make a stable profit out of automatic stock transactions in an intelligent manner by calculating stock investment ratios and selling or buying stocks in response to stock market movement.

In one embodiment of the present invention, the financial asset investment management system includes: a data set for stock investment terms customized for clients, a logic for stock analysis for calculating the stock index of investment based on the stock price and determining the stock investment ratios and stock investment amount, which is connected to a trade execution system, and a logic for transaction for automatic buying and/or selling stocks based on the stock investment terms and the stock investment amount for transaction-buying and/or selling amount in the ever-changing market. The financial asset investment management system makes a stable profit by buying the stock in a synchronized manner with the stock investment ratios to fluctuation of the stock price.

The stock index is calculated based on an index-coupled fund, KODEX200.

The logic for stock analysis analyzes price fluctuations of the stock to be invested for a preassigned temporal period and sets the stock indices at the lowest and highest trading prices of the stock. The current stock index can be calculated using the ratio of the lowest and highest stock prices to the current stock trading price at the time of investment.

Furthermore, the logic for stock analysis calculates the stock investment ratio by a functional equation with the first order, wherein the functional equation is derived from an inversely proportional linear relationship of the current stock index with the highest stock index and the lowest stock index and a stock investment amount based on the stock investment ratio.

Desirably, the logic for stock analysis calculates a optimum stock holding amount from the stock investment ratio, Sₙ, at a point of investment in time, t,

Sₙ=S_{M}+(Sₘ−S_{M})*(1−x) (1)

where Sₘ is the stock investment ratio at the time of the lowest stock index, S_{M} is the stock investment ratio at the time of the highest stock index, and x is the current stock index at the point of investment in time, t.

As an alternative, the logic for stock analysis calculates the stock investment ratio by a functional equation with the second or higher order polynomials, wherein the functional equation is derived from an inversely proportional nonlinear relationship of the current stock index with the highest stock index and the lowest stock index and a stock investment amount based on the stock investment ratio.

In another embodiment of the present invention, the financial asset investment management method for automatically selling/buying stocks through a communication network on a periodic basis includes: collecting a data set of stock investment terms customized for clients; calculating the stock index of investment and determining a stock investment ratio and stock investment amount, which is connected to a trade execution system; and transacting for automatic buying or/and selling stocks based on investment terms, and a stock investment amount to transaction-buying or/and selling amount in the ever-changing market. The financial asset investment management method makes a stable profit by buying the stock in a synchronized manner with the stock investment ratios to fluctuation of the stock price.

The step of calculating the stock index of investment includes analyzing price fluctuations of the stock to be invested for a pre-assigned temporal period and finds the stock indices at the lowest and highest trading prices of the stock. The current stock index can be calculated using the ratio of the lowest and highest stock prices to the current stock trading price at the time of investment.

Furthermore, the step of analyzing the stock index of investment includes calculating the stock investment ratio by a functional equation with the first order, wherein the functional equation is derived from an inversely proportional linear relationship of the current stock index with the highest stock index and the lowest stock index and a stock investment amount based on the stock investment ratio.

Desirably, the step of analyzing the stock index of investment includes calculating the stock investment ratio, Sₙ, at a point of investment in time, t,

Sₙ=S_{M}+(Sₘ−S_{M})*(1−x) (1)

where Sₘ is the stock investment ratio at the time of the lowest stock index, S_{M} is the stock investment ratio at the time of the highest stock index, and x is the current stock index at the point of investment in time, t.

As an alternative, the step of analyzing the stock index of investment includes calculating the stock investment ratio by a functional equation with the second or higher order polynomials, wherein the functional equation is derived from an inversely proportional nonlinear relationship of the current stock index with the highest stock index and the lowest stock index and a stock investment amount based on the stock investment ratio.

### BRIEF DESCRIPTION OF THE DRAWINGS

FIG. 1 shows a block diagram of a financial asset investment system in accordance with one embodiment of the present invention.

FIGS. 2(a) and 2(b) show graphs of a stock investment ratio as functions of stock indices in accordance with another embodiment of the present invention.

FIG. 3 is a table including stock investment amounts and holding amounts of a stock determined by a system according to one embodiment of the present invention and a conventional system.

FIG. 4 shows a flow chart illustrating exemplary steps that may be carried out to manage an asset in accordance with another embodiment of the present invention.

### DETAILED DESCRIPTION

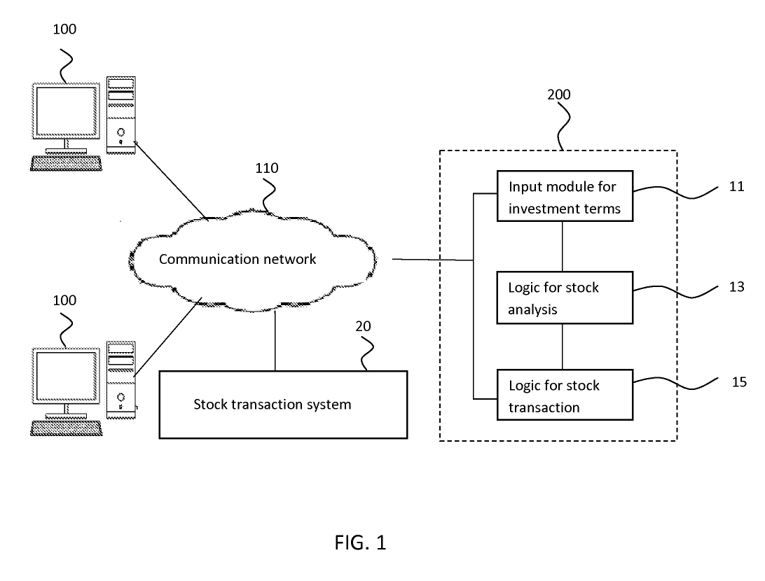

Referring to FIG. 1, FIG. 1 shows a block diagram of a financial asset investment system 200 in accordance with one embodiment of the present invention. The financial asset investment system includes an input module 11 for allowing an investor to enter investment terms, a logic for stock analysis 13, and a logic for stock transaction 15. The input module 11 allows investors to set stock investment terms via terminals 100. The stock investment terms include accounts for stock trading, selected stocks, investment amounts, ratios of investments, investment periods, and desired transaction volumes of stocks. The logic for stock analysis 13 is connected to a stock transaction system 20 via a communication network 110 and checks the current market status, such as current trading price, trade volume, and stock market price.

The logic for stock analysis 13 can be connected to other suitable databases which can be used to check the current market status, such as database in a conventional stock exchange.

The logic for stock transaction 15 determines stock transactions using the information of transaction method, such as investment terms and current market status received from the input module 11 and the logic for stock analysis 13. The logic for stock transaction 15 places an order of transaction and confirms whether the transaction is made as intended.

The logic for stock transaction 15, unlike the conventional rigid system which trades according to the terms of transaction predefined by investors, makes an integrated decision along with information including transaction terms entered by the investors and current market status analyzed by a computer. In this way, the logic for stock transaction 15 makes it possible to automatically execute the transaction in response to the stock market in a quick and active manner.

The financial asset management system 200 periodically checks and analyzes the current market status and makes transaction decisions based on the analyzed current market status and investment ratios entered by the investor such that the investor can minimize loss due to overlooking the market change and optimal investment point in time.

The following example shows a method for making a transaction based on the analyzed current market along with transaction terms/conditions previously defined in a data set of transactions in accordance with an embodiment of the present invention.

In one of embodiment, for a specific stock of interest or target stock, the system 200 analyzes the stock price on a daily/weekly/monthly basis and sets the reference stock indices, compares the current index of the specific stock index with the reference stock indices, and decides whether to sell/buy/hold and adjusts the ratio of investment according to the decision.

The investor can make stable profits and minimize loss from the stock market by responding to the stock market fluctuations in a flexible manner, i.e., by decreasing the investment amount when the current stock index is relatively higher than the reference stock index, and by increasing the investment amount when the current stock index is relatively lower than the reference stock index.

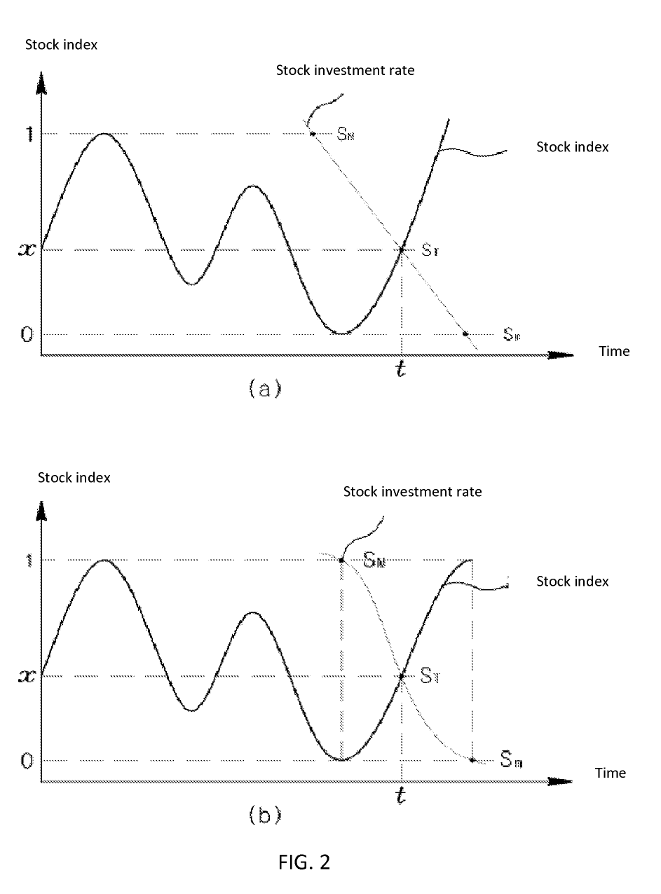

FIGS. 2(a) and 2(b) show graphs of a stock investment ratio as functions of stock indices in accordance with another embodiment of the present invention. When the current stock index is higher than the reference index of the stock, the stock price is set higher than its actual value. In such a case, with reference to the FIGS. 2(a) and 2(b), the investors can decrease the holding amount of the stock to thereby minimize the loss due to the decrease in stock price. When the current stock price is lower than the reference index of the stock, the stock price is set lower than its actual value. In such a case, the investors buy the stock to thereby maximize the profit due to the future increase in stock price.

The logic for stock analysis 13 performs calculation of the stock indices and analysis of investment ratio. The calculation of the stock indices for the target stock is performed by analyzing the data of weekly/monthly/yearly stock price change for the target stock of. The stock index is set to zero when the stock price is lowest during the period of calculation, and is set to one when the stock price is highest during the period of calculation. The current stock index is calculated based on the ratio of the current stock price to the highest and lowest stock prices. In the following exemplary step, the optimum stock holding amount is calculated at a point of investment in time.

As depicted in FIG. 2(a), we can write the equation of the stock investment ratio, Sₙ, at a point of investment in time, t,

Sₙ=S_{M}+(Sₘ−S_{M})*(1−x) (1)

where Sₘ is the stock investment ratio at the time of the lowest stock index, S_{M} is the stock investment ratio at the time of the highest stock index, and x is the current stock index at the point of investment in time, t. The value of x can be determined by calculating a first difference between the highest and lowest stock prices and a second difference between the current and lowest stock prices, and then calculating a price ratio defined as a ratio of the second difference to the first difference. Next, a third difference between the highest stock index (which is “1” in FIG. 2(a)) and the lowest stock index (which is “0” in FIG. 2(a)) is calculated. Then, the price ratio is multiplied to the third difference to obtain the current stock index, x.

Equation (1) is exemplary equation for calculating the stock investment ratio and represents the linear relationship between the stock investment ratio and the current stock index.

In another example, as shown in FIG. 2(b), the stock investment ratio can be calculated by a functional equation with the second or higher order polynomials, wherein the functional equation is derived from an inversely proportional nonlinear relationship of the current stock index with the highest stock index and the lowest stock index and a stock investment amount based on the stock investment ratio.

Again, Sₘ is the stock investment ratio at the time of the lowest stock index and S_{M} is the stock investment ratio at the time of the highest stock index, which can be determined considering the market prices at the lowest and highest stock indices and a predetermined initial ratio of stock investment in the portfolio.

Furthermore, the stock investment amount at the time of investment can be calculated by multiplying a total investment amount by the stock investment ratio derived in the equation (1)

The logic for the stock analysis 13 responds to the market promptly by calculating the stock investment ratio. Also, the logic for transaction 15 makes automatic transactions at the periodic investment points in time and makes stable profits without overlooking the market change and optimal investment point in time.

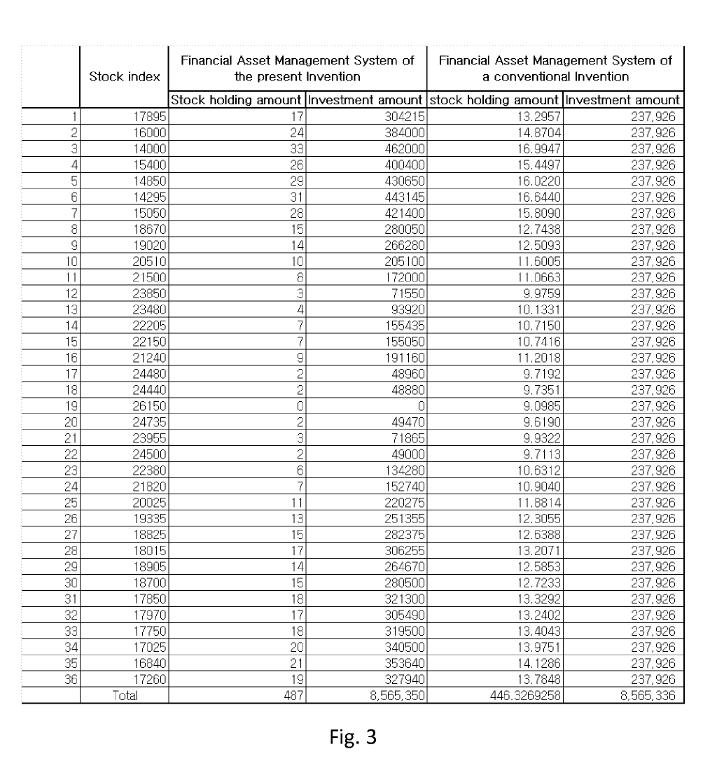

FIG. 3 is a table including the stock investment ratio and stock holding amounts determined by a system according to one embodiment of the present invention and a conventional system.

The conventional financial asset investment system, as shown in the FIG. 3, buys stocks periodically according to a predefined ratio of stock investment. But the financial asset investment system of the invention 200 calculates the stock indices and buys stocks based on the stock investment ratio.

As can be noticed in FIG. 3, the total investment amount is 8,565,336 Wons for the conventional financial asset investment system, while 8,565,350 Wons for the financial asset investment system 200. Thus the difference in total investment amount is negligible. But the total holding/retaining stock amount for the financial asset investment system of the present invention is 487 stocks, while the amount for the conventional financial asset investment system is 446 stocks. Therefore, the financial asset investment system 200 makes more profit than the conventional financial asset investment system.

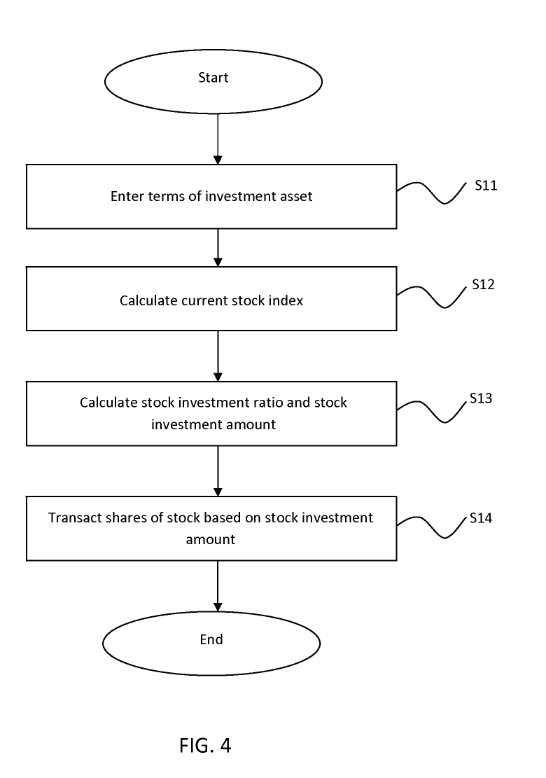

FIG. 4 shows a flow chart illustrating exemplary steps that may be carried out to manage asset in accordance with another embodiment of the present invention.

The process begins in a step S11. In the step S11, an investor enters terms of investment asset including the account of investment, a specific stock to be transacted, total amount of investment money, investment ratio, investment period, and desired amount of trade through the terminal 100. Next, in a step S12, the logic for stock analysis 13 contacts the transaction system of stock exchange 20 to receive information related to the current stock market and calculates the current stock index, “x” in FIGS. 2(a) and 2(b) based on the stock prices.

After analyzing price fluctuations of the specific stock for a pre-assigned temporal period, stock indices are calculated at the lowest and highest trading prices of the stock. The current stock index can be calculated using the ratio of the lowest and highest stock prices to the current stock trading price at the time of investment.

Then, in a step S13, the logic for the stock analysis 13 responds to the market promptly by calculating the stock investment ratio and the stock investment amount based on the current stock index, x.

The stock investment ratio can be calculated by a linear relationship based on the current stock index. Optionally, the stock investment ratio can be also calculated by a functional equation with the second or higher order polynomials in order to respond more adaptively to the market change. Then, the process proceeds to a step S14

In the step S14, the logic for stock transaction 15 automatically buys/sells shares of the stock using the stock investment terms and the stock investment ratio.

While the preferred embodiments of the present invention have been described in detail, it will be understood that modification and adaptation to the embodiments shown may occur to one of ordinary skill in the art without departing from the scope of the present invention as set forth in the following claims. Thus, the scope of the invention is to be construed according to the appended claims and not limited by the specific details disclosed in the exemplary embodiments.

What is claimed is:

1. An investment management system transacting one or more shares of a stock via a network comprising:
an input module for allowing an investor to enter a stock investment term via a terminal connected to the investment management system via the network;
a logic for stock analysis for receiving information from a stock transaction system connected to the investment management system, analyzing the information to calculate a current stock index, and determining a stock investment amount and a ratio of stock investment amount to a total asset amount based on the current stock index; and
a logic for stock transaction for automatically transacting one or more shares of a stock according to the stock investment term and the stock investment amount, wherein the logic for stock analysis analyzes stock price fluctuations of the stock during a preset period to determine a highest stock index corresponding to a highest stock price during the preset period and a lowest stock index corresponding to the lowest stock price during the preset period, calculates ratios of the current stock price to the highest and lowest stock prices, and calculates the current stock index using the ratios, the highest stock index, and the lowest stock index and the logic for stock analysis calculates the stock investment ratio by a functional equation of the first order, wherein the functional equation is derived from an inversely proportional linear relationship of the current stock index with the highest stock index and the lowest stock index and a stock investment amount based on the stock investment ratio in response to a change of the current stock index.

2. The investment management system of claim 1, wherein the stock index is calculated based on an index-coupled fund, KODEX200.

3. The investment management system of claim 1, wherein the logic for stock analysis calculates the stock investment ratio calculated by a functional equation of second or higher order polynomials, wherein the functional equation of second or higher order polynomials is derived from an inversely proportional nonlinear relationship of the current stock index with the highest stock index and the lowest stock index and the stock investment amount based on the stock investment ratio in response to the change of the current stock index.

4. The investment management system of claim 2, wherein the logic for stock analysis calculates the stock investment ratio calculated by a functional equation of second or higher order polynomials, wherein the functional equation of second or higher order polynomials is derived from an inversely proportional nonlinear relationship of the current stock index with the highest stock index and the lowest stock index and the stock investment amount based on the stock investment ratio in response to the change of the current stock index.

5. The investment management system of claim 1, wherein the stock investment ratio, S_{T}, is determined according to the equation
S_{T}=S_{M}+(Sₘ−S_{M})*(1−x)
where Sₘ is a stock investment ratio at a time of the lowest stock price, S_{M} is a stock investment ratio at a time of the highest stock price, and x is the current stock index.

6. A method for automatically transacting one or more shares of a stock, comprising:
collecting a data set of stock investment terms input by an investor using a terminal connected to a network;
receiving, from a stock transaction system, information related to the stock and determining a current stock index corresponding to a current stock price;
analyzing the stock by determining a stock investment amount and a ratio of stock investment amount to a total asset amount based on the current stock index; and
automatically transacting one or more shares of a stock according to the data set of stock investment terms and the stock investment amount, wherein the step for analyzing analyzes stock price fluctuations of the stock during a preset period to determine a highest stock index corresponding to a highest stock price during the preset period and a lowest stock index corresponding to the lowest stock price during the preset period, calculates ratios of the current stock price to the highest and lowest stock prices, and calculates the current stock index using the ratios, the highest stock index, and the lowest stock index and the step for analyzing calculates the stock investment ratio by a functional equation of the first order, wherein the functional equation is derived from an inversely proportional linear relationship of the current stock index with the highest stock index and the lowest stock index and the stock investment amount based on the stock investment ratio in response to a change of the current stock index.

7. The method of claim 6, wherein the stock index is calculated based on an index-coupled fund, KODEX200.

8. The method of claim 6, wherein the step for stock analysis includes calculating the stock investment ratio calculated by a functional equation of second or higher order polynomials, wherein the functional equation of second or higher order polynomials is derived from an inversely proportional nonlinear relationship of the current stock index with the highest stock index and the lowest stock index and the stock investment amount based on the stock investment ratio in response to the change of the current stock index.

9. The method of claim 7, wherein the step for stock analysis includes calculating the stock investment ratio calculated by a functional equation of second or higher order polynomials, wherein the functional equation of second or higher order polynomials is derived from an inversely proportional nonlinear relationship of the current stock index with the highest stock index and the lowest stock index and the stock investment amount based on the stock investment ratio in response to the change of the current stock index.

10. The method of claim 6, wherein the stock investment ratio, S_{T}, is determined according to the equation
S_{T}=S_{M}+(Sₘ−S_{M})*(1−x)
where Sₘ is a stock investment ratio at a time of the lowest stock price, S_{M} is a stock investment ratio at a time of the highest stock price, and x is the current stock index.
